(19) United States
(12) Patent Application Publication
(10) Pub. No.: US 2026/0013561 A1
(43) Pub. Date: Jan. 15, 2026

(54) HEATER ASSEMBLY AND METHOD

(71) Applicant: Nicoventures Trading Limited, London (GB)

(72) Inventors: Howard ROTHWELL, London (GB); Ugurhan YILMAZ, London (GB)

(21) Appl. No.: 19/130,389

(22) PCT Filed: Nov. 10, 2023
(86) PCT No.: PCT/GB2023/052945

§ 371 Date: May 15, 2025

(30) Foreign Application Priority Data
Nov. 15, 2022 (GB) 2217024.5

(51) Int. Cl. A24F 40/46; A24F 40/10; A24F 40/42; A24F 40/44; A24F 40/485; A24F 40/70

(52) U.S. Cl. CPC A24F 40/46; A24F 40/44; A24F 40/485; A24F 40/70; A24F 40/10; A24F 40/42

(57) ABSTRACT

Described is a heater assembly for an aerosol provision system, the heater assembly including: a substrate; a heater layer configured to generate heat when supplied with energy, the heater layer provided on a first surface of the substrate; and one or more capillary tubes extending from another surface of the substrate through the heater layer provided at the first surface of the substrate, wherein the thickness of at least one of the heater layer and substrate is set so as to be different at different portions of the heater assembly. Also described is an aerosol provision system comprising a heater assembly and a method for manufacturing a heater assembly.

### CROSS-REFERENCE TO RELATED APPLICATIONS

This present application is a National Phase entry of PCT Application No. PCT/GB2023/052945, filed 10 Nov. 2023, which claims priority from Great Britain Application No. 2217024.5, filed 15 Nov. 2022, each of which are fully incorporated herein by reference in their entireties.

### FIELD

The present disclosure relates to electronic aerosol provision systems such as nicotine delivery systems (e.g. electronic cigarettes and the like).

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporisation. An aerosol source for an aerosol provision system may thus comprise a heater having a heating element arranged to receive source liquid from the reservoir, for example through wicking/capillary action. While a user inhales on the device, electrical power is supplied to the heating element to vaporise source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Typically, such electronic aerosol provision systems are provided with heater assemblies suitable for heating the source liquid to form an aerosol. An example of such a heater assembly is a wick and coil heater assembly, which is formed of a coil of wire (typically nichrome NiCr 8020) wrapped or coiled around a wick (which typically comprises a bundle of collected fibres, such as cotton fibres, extending along the longitudinal axis of the coil of wire). Ends of the wick extend either side of the coil of wire and are inserted into the reservoir of source liquid. However, such heater assemblies are not necessarily suited for all applications or all configurations of electronic aerosol provision systems.

So-called microfluidic heater assemblies have been proposed to try to address some of the issues of the abovementioned heater assemblies. However, some microfluidic heater assemblies may not provide desired heating characteristics for certain applications.

Various approaches are described which seek to help address some of these issues.

### SUMMARY

According to a first aspect of certain embodiments there is provided a heater assembly for an aerosol provision system, the heater assembly including: a substrate; a heater layer configured to generate heat when supplied with energy, the heater layer provided on a first surface of the substrate; and one or more capillary tubes extending from another surface of the substrate through the heater layer provided at the first surface of the substrate. The thickness of at least one of the heater layer and substrate is set so as to be different at different portions of the heater assembly.

According to a second aspect of certain embodiments there is provided an aerosol provision system comprising the heater assembly of the first aspect.

According to a third aspect of certain embodiments there is provided a method for manufacturing a heater assembly for an aerosol provision system, the method including: providing a substrate; providing a heater layer on a first surface of the substrate, the heater layer configured to generate heat when supplied with energy; and providing one or more capillary tubes extending from another surface of the substrate through the heater layer provided at the first surface of the substrate. The thickness of at least one of the heater layer and substrate is set so as to be different at different portions of the heater assembly.

According to a fourth aspect of certain embodiments there is provided heater means for an aerosol provision system, the heater means including: a substrate; heater layer means configured to generate heat when supplied with energy, the heater layer means provided on a first surface of the substrate; and capillary means extending from another surface of the substrate through the heater layer means provided at the first surface of the substrate, wherein the thickness of at least one of the heater layer means and substrate is set so as to be different at different portions of the heater means.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the invention will now be described, by way of example only, with reference to the accompanying drawings, in which:

FIG. 1 is a perspective view of an aerosol provision system in accordance with aspects of the present disclosure;

FIG. 2 is an exploded perspective view of a cartomiser suitable for use in the aerosol provision system of FIG. 1;

FIG. 3 is a perspective view of a heater assembly in accordance with aspects of the present disclosure, wherein the heater assembly comprises a substrate, an electrically resistive layer, and capillary tubes extending through the substrate and electrically resistive layer;

FIGS. 4a and 4b are schematic representation of a heater assembly according to a first implementation in which the thickness of the electrically resistive layer is different in a central region of the heater assembly; FIG. 4a shows the heater assembly in cross-section, while FIG. 4b shows the heater assembly in a perspective view where the electrically resistive layer is substantially visible;

FIGS. 5a and 5b are schematic representation of a heater assembly according to a second implementation in which the thickness of the substrate is different in a central region of the heater assembly; FIG. 5a shows the heater assembly in cross-section, while FIG. 5b shows the heater assembly in a perspective view where the electrically resistive layer is substantially hidden from view; and

FIG. 6 is a method in accordance with aspects of the present disclosure for forming a heater assembly.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device, electronic cigarette or electronic nicotine delivery system (END), although it is noted that the presence of nicotine in the aerosol-generating material is not a requirement. Throughout the following description the term “e-cigarette” is sometimes used but this term may be used interchangeably with aerosol (vapour) provision system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

In some embodiments, the or each aerosol-generating material may comprise one or more active constituents, one or more flavours, one or more aerosol-former materials, and/or one or more other functional materials.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or is derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

Typically, the non-combustible aerosol provision system may comprise a non-combustible aerosol provision device and a consumable for use with the non-combustible aerosol provision device. In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a mouthpiece, and/or an aerosol-modifying agent.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

In accordance with the present disclosure, a heater assembly, that comprises an electrically resistive layer capable of generating heat when a current is applied thereto and a substrate on a surface of which is disposed the electrically resistive layer, is configured such that the thickness of at least one of the electrically resistive layer and the substrate is set so as to be different at different portions of the heater assembly. Altering the relative thickness of the electrically resistive layer and/or substrate at a first region or portion of the heater assembly compared to a second region or portion is considered to impact the operational temperature that is achievable by the electrically resistive layer at the first region or portion. In particular, this allows for the heating characteristics across the electrically resistive layer to be altered as desired; for example, to provide uniform heating across the heater assembly.

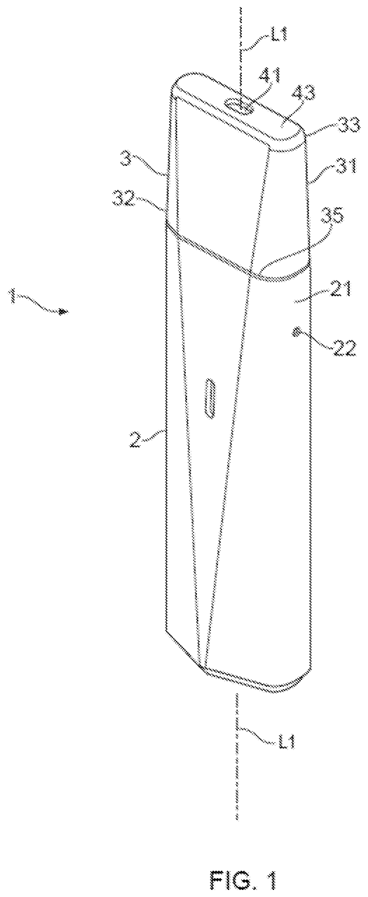

FIG. 1 schematically shows an aerosol provision system 1 in accordance with aspects of the present disclosure. The aerosol provision system 1 comprises an aerosol provision device 2 and a consumable 3, herein shown and referred to as a cartomiser 3. The aerosol provision device 2 and the cartomiser 3 together form the aerosol provision system 1.

The cartomiser 3 is configured to engage and disengage with the aerosol provision device 2. That is, the cartomiser 3 is releasably connected/connectable to the aerosol provision device 2. More specifically, the cartomiser 3 is configured to engage/disengage with the aerosol provision device 2 along the longitudinal axis L1. The cartomiser 3 and aerosol provision device 2 are provided with suitable interfaces to allow the cartomiser 3 and aerosol provision device 2 to engage/disengage from one another, e.g., a push fit interface, a screwthread interface, etc.

The cartomiser 3 comprises a reservoir which stores an aerosol-generating material. Accordingly, the reservoir may also be referred to as an aerosol-generating material storage portion. In the following, the aerosol-generating material is a liquid aerosol-generating material. The liquid aerosol-generating material (herein sometimes referred to simply as liquid, source liquid or e-liquid) may be a conventional e-liquid which may or may not contain nicotine. However, it should be appreciated that other liquids and/or aerosol-generating materials may be used in accordance with the principles of the present disclosure. The cartomiser 3 is able to be removed from the aerosol provision device 2 when, for example, the cartomiser 3 requires refilling with liquid or replacement with another (full) cartomiser 3.

The aerosol provision device 2 comprises a power source (such as a rechargeable battery) and control electronics. As will be described below, the cartomiser 3 comprises an electrically powered heater assembly. When the cartomiser 3 is coupled to the aerosol provision device 2, the control electronics of the aerosol provision device 2 are configured to supply electrical power to the heater assembly of the cartomiser 3 to cause the heater assembly to generate an aerosol from the liquid aerosol-generating material supplied thereto. The control electronics may be provided with various components to facilitate/control the supply of power to the cartomiser 3. For example, the control electronics may be provided with an airflow sensor (not shown) configured to detect when a user of the aerosol provision system 1 inhales on the aerosol provision system and to supply power in response to such a detection and/or a push button (not shown) which is pressed by the user and to supply power in response to such a detection. Additional functions may be controlled by the control electronics depending on the configuration of the aerosol provision device 2 (for example, the control electronics may be configured to control/regulate recharging of the power source, or to facilitate wireless communication with another electronic device, such as a smartphone). The features and functions of the aerosol provision device 2 are not of primary significance in respect of the present disclosure.

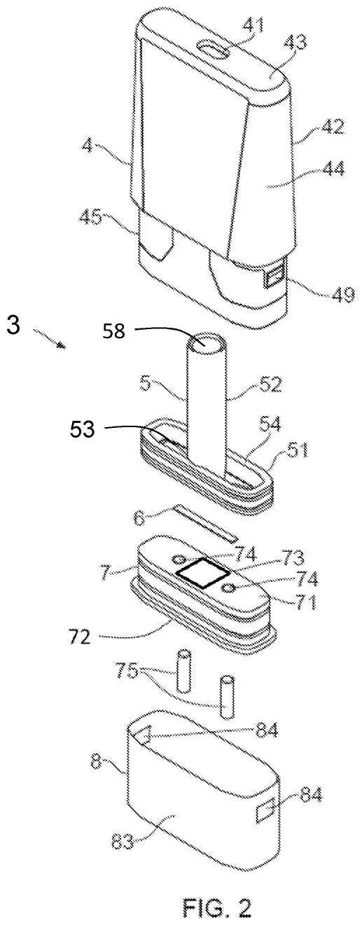

FIG. 2 shows an example cartomiser 3 suitable for use in the aerosol provision system of FIG. 1. From the exploded view of FIG. 2, it may be seen that the cartomiser 3 is assembled from a stack of components: an outer housing 4, an upper clamping unit 5, a heater assembly 6, a lower support unit 7 and an end cap 8.

The cartomiser 3 has a top end 31 and a bottom end 32 which are spaced apart along the longitudinal axis L1, which is the longitudinal axis of the cartomiser as well as being the longitudinal axis of the aerosol provision system 1. The top end 31 of the cartomiser 3 defines a mouthpiece 33 of the aerosol provision system 1 (around which a user may place their mouth and inhale). The mouthpiece 33 includes a mouthpiece orifice 41 which is provided at the top end 42 of outer housing 4 in the centre of a top face 43.

The outer housing 4 includes a circumferential side wall 44 which leads down from the top end 42 to a bottom end 45 of the outer housing 4 and which defines an internal reservoir 46 for holding the liquid aerosol-generating material. Prior to assembly of the cartomiser 3, the bottom end 45 of the outer housing is open, but upon assembly the bottom end 45 is closed by a plug formed by the upper clamping unit 5 and the lower support unit 7 which are stacked together with the heater assembly 6 sandwiched therebetween.

The upper clamping unit 5 is an intermediate component of the stack of components. The upper clamping unit 5 includes a foot 51 in the form of a block and an upwardly extending air tube 52. On each side of the air tube 52, the foot 51 includes a well 53 which descends from a flat top surface 54 to a flat bottom surface (not shown in FIG. 2) of the foot 51. At the bottom surface, each well 53 is open and, specifically, opens into an elongate recess formed in the bottom surface, with the depth of the recess broadly matching the size/shape and thickness of the heater assembly 6. The foot 51 is designed to engage with the outer housing 4 (more specifically, such that the outer circumferential surface of the foot is pressed against an inner circumferential surface of the outer housing 4). The foot 51 may have a suitable shape and include suitable sealing components to reduce or prevent liquid from leaking between the outer surface of the foot 51 and the inner surface of the housing 4.

The air tube 52 extends up from the bottom of the wells 53 and defines an internal air passage 58. When the upper clamping unit 5 is engaged with the outer housing 4, the air tube 52 extends up to and encircles the mouthpiece orifice 41. The outer housing 4 and/or the air tube 52 may be suitably configured so as to provide a liquid-(and optionally air-) tight seal between the two. As will be understood below, air/aerosol is intended to pass along the air tube 52 and out of the mouthpiece orifice 41, while the space around the air tube 52 and within the outer housing 4 defines the reservoir 46 for storing the liquid aerosol-generating material. Hence, it should be understood that, with the exception of the openings of the wells 53, the reservoir 46 is a sealed volume defined by the outer housing 4, the outer surface of the air tube 52, and the foot 51.

The lower support unit 7 is in the form of a block having a broadly flat top surface 71 and a flat bottom surface 72. A central air passage 73 extends upwardly from the bottom surface 72 to the top surface 71. On each side of the air passage 73, the block of the lower support unit 7 includes a through hole 74. In the example cartomiser 3 of FIG. 2, a co-moulded contact pad 75 in the form of a pin is inserted into the through holes 74. More specifically, each contact pad 75 is a press fit in its respective through hole 74. Each contact pad 75 provides an electrical connection path from the bottom surface 72 to a respective end portion of the heater assembly 6 when the heater assembly 6 is sandwiched between the top surface 71 of the lower support unit 7 and the recess of the bottom surface 55 of the upper clamping unit 5.

Much like the upper clamping unit 5, the lower support unit 7 is designed to engage with the outer housing 4 (more specifically, such that the outer circumferential surface of the lower support unit 7 is pressed against an inner circumferential surface of the outer housing 4). The lower support unit 7 may have a suitable shape and include suitable sealing components to reduce or prevent liquid from leaking between the outer surface of the lower support unit 7 and the inner surface of the housing 4. The foot 51 of the upper clamping unit 5 and the lower support unit 7 (with its block-like form) combine together to form a plug which seals the bottom end of the reservoir 46.

As shown in FIG. 2, the cartomiser 3 includes an end cap 8 at its bottom end. The end cap 8 is made of metal and serves to assist with retaining the cartomiser 3 in the aerosol provision device 2 when the cartomiser 3 is plugged in to the top end of the aerosol provision device 2, because, in this example, the aerosol provision device 2 is provided with magnets which are attracted to the metal of the end cap 8. The end cap 8 has a bottom wall 81 with a central opening (not shown in FIG. 2). The end cap 8 also has a circumferential side wall 83 which has two opposed cut-outs 84 which latch onto corresponding projections 49 on the outer surface of the bottom end of the side wall 44 of the outer housing 4, so that the end cap 8 has a snap-fit type connection onto the bottom end of the outer housing 4. When the end cap 8 has been fitted in position, it holds in position the lower support unit 7, the upper clamping unit 5 and the heater assembly 6 which is sandwiched between the lower support unit 7 and the upper clamping unit 5.

It would be possible to omit the end cap 8 (in order to reduce the component count) by arranging for the lower support unit 7 to form a snap-fit type connection with the bottom end of the side wall 44 of the outer housing 4. Additionally, the cartomiser 3 could be provided with indentations which engage with projections at the top end 21 of the main housing 2, so that a releasable connection is provided between the cartomiser and the main housing.

In any case, the cartomiser 3 is provided what may more generally be referred to as a device interface which is a part of the cartomiser 3 that interfaces with the main housing 2 (or aerosol-generating device). In the above example, the device interface may include the metal cap 8 including the bottom wall 81 and circumferential side wall 83 and/or the lower support unit 7 including the bottom surface 72. More generally, the device interface of the cartomiser 3 may encompass any part or parts of the cartomiser 3 that contact, abut, engage or otherwise couple to the main housing 2.

When the components of the cartomiser 3 have been assembled together, an overall air passage exists from the bottom end 32 to the top end 31 of the cartomiser 3 and it is formed by the air passage 73 leading to the air passage 58 which, in turn, leads to the mouthpiece orifice 41. Where the air passage 73 meets the air passage 58, the air flow bifurcates as it passes around the side edges of the heater assembly 6.

With reference back to FIG. 1, the top end 21 of the aerosol provision device 2 includes an air inlet hole 22 on each side of the aerosol provision device 2 (with one of the two air inlet holes 22 being visible in FIG. 1). Air can enter the air inlet holes 22 and flow transversely inwards to the longitudinal axis L1 so as to enter the bottom end of the air passage 73 of the lower support unit 7 and to start to flow in the direction of the longitudinal axis L1 towards the mouthpiece 33.

In addition, when the components of the cartomiser 3 have been assembled, the heater assembly 6 is arranged such that the ends thereof are in fluid communication with the wells 53 (or openings to the wells 53). Liquid aerosol-generating material in the reservoir 46 is therefore able to pass to the ends of the heater assembly 6 via the wells 53. Liquid aerosol-generating material is also permitted to travel along the longitudinal direction of the heater assembly 6, e.g., to regions of the heater assembly 6 that are not in direct contact with the reservoir 46, such as a region of the heater assembly that is provided in the air passage 73 or air passage 58. Any suitable arrangement may be provided to facilitate the transfer of liquid along the longitudinal direction. For example, in some implementations, a wicking material, such as cotton or glass fibres, formed as a layer may be provided between the heater assembly 6 and the upper clamping unit 5, where the wicking material is in contact with the wells 53 and capable of transporting the liquid aerosol-generating material in the longitudinal direction. Additionally or alternatively, the heater assembly 6 itself may be formed with one or more channels permitting the transport of liquid aerosol-generating material along the length of the heater assembly 6. For example, in some implementations, the heater assembly 6 may be formed from a porous substrate (such as a sintered material or a ceramic) and/or have channels formed (such as through drilling or other machining) along the length of the heater assembly 6. Accordingly, even though only a part of the heater assembly 6 in FIG. 2 is shown in contact with the wells 53, liquid is capable of travelling along the length of the heater assembly.

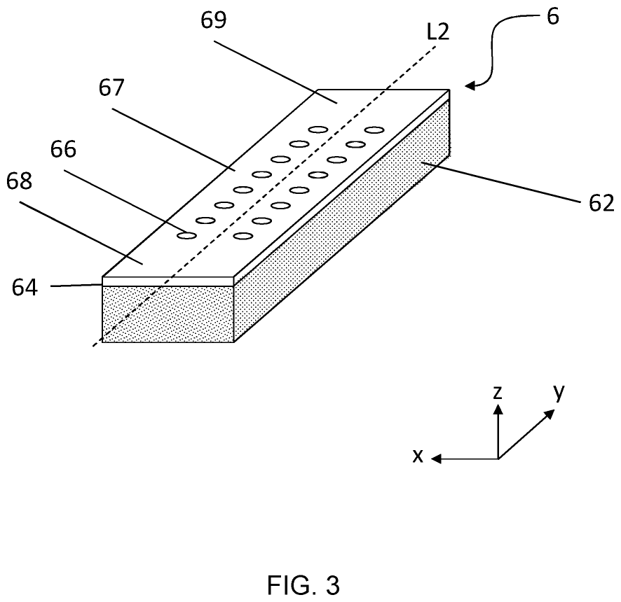

Turning now to the heater assembly 6, the heater assembly 6 is a microfluidic heater assembly. FIG. 3 illustrates the microfluidic heater assembly 6 in more detail.

The microfluidic heater assembly 6 comprises a substrate 62 and an electrically resistive layer 64 disposed on a surface of the substrate 62.

In this implementation, the substrate 62 is formed from a non-conductive material, such as quartz (silicon dioxide); however, it should be appreciated that other suitable non-conductive materials may be used, such as ceramics or silicon oxide, for example. As noted above, the substrate 62 in some implementations may be formed from a porous material. The porous substrate 62 may be formed from naturally porous materials, such as sponges, porous stones or ceramics etc., or via materials that are engineered to be porous, such as sintered metals or other materials. These materials, either formed naturally or engineered, have pores or hollow regions which are interconnected and define passages that follow a substantially random pathway through the material. In other implementations, the substrate 62 may be considered substantially impermeable. The way in which the substrate 62 is formed and the materials it is made therefrom is not of primary significance to the principles of the present disclosure.

The electrically resistive layer 64 is formed from any suitable electrically conductive material, for example a metal or a metal alloy such as titanium or nickel chromium. The electrically resistive layer 64 may be formed on the surface of the substrate 62 in any suitable way. For example, the electrically resistive layer 64 may be provided as a film that is adhered or otherwise bonded to the surface of the substrate 62. Alternatively, the electrically resistive layer 64 may be formed though a deposition technique, such as chemical or vapour deposition. The way in which the electrically resistive layer 64 is formed and the materials it is made therefrom is not of primary significance to the principles of the present disclosure.

The heater assembly 6 is planar and in the form of a rectangular cuboidal block, elongate in the direction of a longitudinal axis L2. FIG. 3 includes a Cartesian co-ordinate reference for the heater assembly 6 shown in FIG. 3, where the x-axis of the Cartesian co-oridinate reference is parallel to the longitudinal axis L2. The heater assembly 6 has the shape of a strip and has parallel sides. The planar heater assembly 6 has parallel upper and lower major (planar) surfaces and parallel side surfaces and parallel end surfaces. The heater assembly has a length along the x-axis direction, a width along the y-axis direction and a thickness along the z-axis direction. In the shown implementation of FIG. 3, the length of the heater assembly 6 is 10 mm and its width is 1 mm. As will be discussed below in more detail, the thickness of the heater assembly 6 is not uniform across the length and/or width of the heater assembly 6. However, broadly speaking, in the shown implementation of FIG. 3, the average thickness of the heater assembly is on the order of 0.12 mm (where the average thickness of the substrate 62 is approximately 0.10 mm, and the average thickness of the electrically resistive layer 64 is approximately 0.02 mm). The small size of the heater assembly 6 enables the overall size of the cartomiser 3 to be reduced and the overall mass of the components of the cartomiser 3 to be reduced. However, it should be appreciated that in other implementations, the heater assembly 6 may have different dimensions depending upon the application at hand. For example, in some implementations, the heater assembly 6 may be a 3×3 mm chip.

Along the longitudinal axis L2, the heater assembly 6 has a central portion 67 and first and second end portions 68, 69. In FIG. 3, the length of the central portion 67 (relative to the lengths of the end portions 68, 69) has been exaggerated for reasons of visual clarity. When the vaporizer is in situ in the cartomiser, the central portion 67 is positioned in the air passage 73. The central portion 67 extends across the top end of the air passage 73 of the lower support unit 7, and across the bottom end of the air passage 58 of the upper clamping unit 5. The end portions 68, 69 are clamped between the upper clamping unit 5 and the lower support unit 7.

In the central portion 67 of the heater assembly 6, a plurality of capillary tubes 66 are provided. Only the openings of the capillary tubes 66 are shown in FIG. 3 (and in an exaggerated way for clarity), but the capillary tubes 66 extend from one side of the heater assembly 6 to the other. More specifically, the capillary tubes extend from the side of the heater assembly 6 opposite the electrically resistive layer 64 (the largest surface not shown in FIG. 3), through the substrate 62 toward the face of the substrate 62 on which the electrically resistive layer 64 is disposed, and then through the electrically resistive layer 64. The plurality of capillary tubes 66 extend substantially linearly through the heater assembly 6 (that is, the capillary tubes 66 follow substantially linear paths). By substantially, it is meant that the capillary tubes 66 follow pathways that are within 5%, within 2% or within 1% of a straight line. This measure may be obtained in any suitable way, e.g., by comparison of the length of the distance from a first point to a second point along the extent of the capillary tube 66 and the corresponding distance that the central axis of the capillary tube 66 extends between the same two points. The capillary tubes 66 are formed in the heater assembly 66 via a manufacturing process. That is to say, the capillary tubes 66 do not naturally exist in the substrate material 62 or electrically resistive layer 64, but rather, the capillary tubes 66 are formed in the substrate material 62 and electrically resistive layer 64 through a suitable process. A suitable process for forming the capillary tubes 66, particularly when forming capillary tubes that substantially follow a linear path, is laser drilling. However, any other suitable technique may be employed in order to generate the capillary tubes 66.

The capillary tubes 66 are configured so as to transport liquid from one surface of the heater assembly 6 (i.e., the surface of the substrate 62 opposite the electrically resistive layer 64) to the electrically resistive layer 64. The capillary tubes 66 may be formed based in part on the liquid to be stored in the reservoir 46 of the cartomiser 3 and subsequently used with the heater assembly 6. For example, the properties of the liquid aerosol-generating material (e.g., viscosity) in the reservoir 46 of the cartomiser 3 may dictate the configuration of the capillary tubes 66 to ensure that a suitable flow of liquid is provided to the electrically resistive layer 64. Broadly speaking, in some implementations, the capillary tubes 66 may have a diameter on the order to tens of microns, e.g., between 10 μm to 100 μm. However, it should be appreciated that capillary tubes 66 in other implementations may be set differently.

The heater assembly 6 as described above is generally provided as a relatively small component having a relatively small footprint (as compared to more traditional heater assemblies, such as a wick and coil). This is in part due to the fact the capillary tubes 66 are formed via a manufacturing process in the heater assembly 6 (i.e., the capillary tubes are engineered, e.g., through a laser drilling process), and can therefore be designed to achieve a desired delivery of liquid aerosol-generating material to the electrically resistive layer 64. By providing a smaller component, material wastage (e.g., when the cartomiser 3 is disposed of) can be reduced. Not only can the liquid be provided more efficiently to the electrically resistive layer 64, but by manufacturing the capillary tubes 66, more control is given over the supply of liquid to the electrically resistive layer 64 (that is, the more capillary tubes of a certain diameter, the more liquid per unit time (ml/s) can be delivered to the electrically resistive layer 64).

With reference back to FIG. 2, the heater assembly 6 is shown positioned between the upper clamping unit 5 and the lower support unit 7. In particular, the heater assembly 6 is oriented such that the electrically resistive layer 64 faces towards the lower support unit 7, while the substrate 62 facing towards the upper clamping unit 5. It should be understood from FIG. 2 that the end portions 68, 69 of the heater assembly 6 overlap the through holes 74 and the contact pads 75. More specifically, the electrically resistive layer 64 is provided in contact with the contact pads 75, and therefore the end portions 68, 69 act to form an electrical connection with the contact pads 75 (and thus any power source subsequently attached to the contact pads 75, such as from the aerosol provision device 2). For example, the aerosol provision device 2 may have two power supply pins (not shown) which make contact with the bottom ends of the contact pads 75. The top ends of the contact pads 75 are in electrical contact with the heater assembly 6, as above. In use, electrical power supplied by the power supply of the aerosol provision device 2 passes through the electrically resistive layer 64, by virtue of the electrical connection between the end portions 68, 69 and the contact pads 75, to cause heating of the electrically resistive layer 64.

The amount of heating achieved (i.e., the temperature of the electrically resistive layer 64 that is able to be reached) may depend in part on the power supplied by the aerosol provision device 2, the electrical resistance of the electrically resistive layer 64 and the heating efficiency of the heater assembly 6 (in particular, how much of the heating energy is lost to the substrate 62 and/or environment around the electrically resistive layer 64). Equally, the amount of heating required (i.e., the temperature necessary to vaporise the liquid supplied to the resistive layer 64) will be dependent in part on the properties of the liquid supplied to the electrically resistive layer 64.

For a given current applied to the electrically resistive layer 64 of the heater assembly 6, the resistance of the electrically resistive layer 64 may be set based on the particular implementation, whereby the resistance of the electrically resistive layer 64 may be dependent on the material of the electrically resistive layer 64 and the physical dimensions of the electrically resistive layer 64 (e.g., thickness).

It has been found that, during use of the heater assembly, that is when an electrical current is applied to the electrically resistive layer 64 of the microfluidic heater assembly 6, the temperatures across the electrically resistive layer 64 are not uniform. That is to say, different regions of the electrically resistive layer 64 may reach higher temperatures than other regions of the electrically resistive layer 64 when operated. Regions of the electrically resistive layer 64 where the temperature is relatively higher may be referred to as “hot-spots” of the electrically resistive layer 64. These “hot-spots” may be the result of one or more features of the heater assembly 6 and/or the cartomiser 3. For example, “hot-spots” may occur due to the application of an electric current to the electrically resistive layer 64, whereby variations in the flow of current across the electrically resistive layer 64 and/or variations in the resistance of the electrically resistive layer 64 may cause certain regions of the electrically resistive layer 64 to reach greater temperatures than others. Additionally, or alternatively, “hot-spots” may occur due to a cooling effect applied to the heater assembly 6 only being applied in certain regions or only having an effect in certain regions. Such cooling effects may include the mass of liquid supplied to certain regions of the heater assembly 6, for example where a greater mass or a greater mass flow rate in certain regions of the heater assembly 6 may lead to cooling of the electrically resistive layer 64 in those regions. Alternatively, cooling may be due to the direction and/or extent of coverage of an air flow towards or in the vicinity of the heater assembly 6, whereby air flow that impinges or otherwise passes by regions of the heater assembly may help cool those regions. Subsequently, the absence or reduced effectiveness of such cooling mechanism in a particular heater assembly 6 or configuration of cartomiser 3 can lead to the formation of “hot-spots”.

With reference to the example heater assembly of FIG. 3, even excluding the end portion 68, 69 which are configured substantially for a different purpose than the central portion 67, hot-spots may appear within the central portion 67 of the heater assembly (where this portion comprises the capillary tubes 66). For the rectangular cuboid shaped heater assembly 6 described above in the configuration of the cartridge 3 as described above, hot-spots may be seen to appear within a central region of the central portion 67 of the heater assembly 6. That is to say, of the central portion 67, a central region of the central portion 67 may be at a generally higher temperature during operation than an outer or peripheral region of the central portion 67 that surrounds the central region of the central portion 67. In use, this means that liquid that is supplied to the electrically resistive layer 64 from one capillary tube 66 may not be heated to the same extent as liquid supplied to the electrically resistive layer 64 from another capillary tube 66 (where the two capillary tubes are provided in different regions of the central portion 67 of the heater assembly 6).

In accordance with the present disclosure, the heater assembly 6 is modified such that the thickness of at least one of the electrically resistive layer 64 or substrate 62 is set so as to be different at different portions of the heater assembly 6. By varying the thickness of the electrically resistive layer 64 and/or the substrate 62 in different regions of the heater assembly 6, the heating characteristics of the electrically resistive layer 64 may be varied in different regions of the electrically resistive layer 64. For example, the heating characteristic of the electrically resistive layer 64 may be made to be more uniform, such that the variation in operational temperatures across the electrically resistive layer 64 (or at least across a portion of the heater assembly 6 comprising the capillary tubes 66) can be made less by adjusting the thickness of the electrically resistive layer 64 and/or the substrate 62 in different regions of the heater assembly 6.

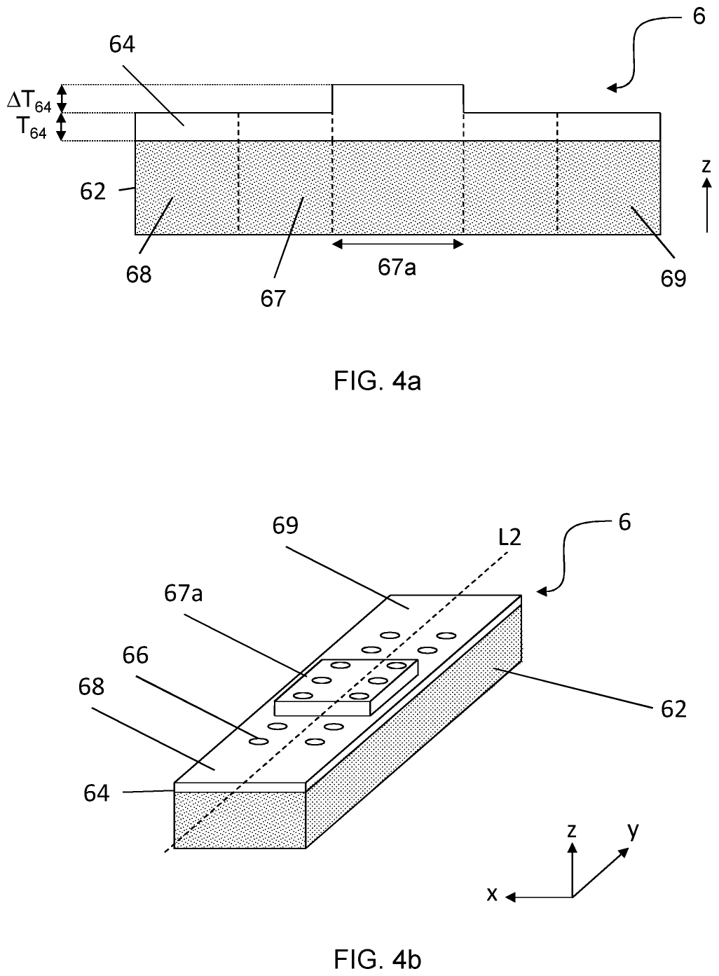

FIGS. 4a and 4b schematically represent a heater assembly 6 employing the principles of the present disclosure according to a first implementation. FIG. 4a shows the heater assembly 6 in cross-section taken along the longitudinal axis L2 of the heater assembly 6. FIG. 4b shows a perspective view of the heater assembly where the electrically resistive layer 64 is substantially visible. Each of FIGS. 4a and 4b will be understood from FIG. 3, and like components are labelled with common reference signs. An explanation of these components is not repeated herein and instead the reader is referred to the description above.

FIG. 4a shows a cross-sectional view of the heater assembly 6, and in particular, shows the thicknesses of the substrate 62 and electrically resistive layer 64 (where, as described with respect to the orientation of FIG. 3, the thickness corresponds to the dimension of the substrate 62/electrically resistive layer 64 in the z-axis direction). Also shown in FIG. 4a are the different portions of the heater assembly 6. In particular, to the left of the heater assembly 6 as viewed in FIG. 4a is shown end portion 68 which is demarked from the central portion 67 by the leftmost dashed line, and to the right of the heater assembly 6 as viewed in FIG. 4a is shown end portion 69 which is demarked from the central portion 67 by the rightmost dashed line. In between the end portions 68, 69 is shown the central portion 67 which extends from the leftmost dashed line to the rightmost dashed line in FIG. 4a. Although not shown in FIG. 4a, the central portion comprises one or more capillary tubes 66 that extend substantially in the z-axis direction from the surface of the substrate 62 opposite the electrically resistive layer 64 and through the electrically resistive layer 64, as described above.

FIG. 4a also shows a central region 67a of the central portion 67 of the heater assembly 6. The central region 67a is demarked by the innermost dashed lines in FIG. 4a and also by the double-ended arrow labelled 67a. For the purposes of this discussion, it is assumed that for a heater assembly 6 as shown in FIG. 3, where the electrically resistive layer 64 is substantially uniform across the length, width and thickness of the central portion 67, an equivalent region corresponding to the central region 67a is a region of the electrically resistive layer 64 which in use may experience a temperature that is slightly greater than the temperature of the surrounding region of the central region 67a. In other words, the central region 67a is a region which would otherwise be a so-called “hot-spot” in use. For completeness, the regions of the central portion 67 which are not considered to be the central region 67a (i.e., the regions between the dashed lines to the left and right of the central region 67a) are considered to represent a different region of central portion 67 of the heater assembly 6. For the purposes of this discussion, it is assumed that for a heater assembly 6 as shown in FIG. 3, where the electrically resistive layer 64 is substantially uniform across the length, width and thickness of the central portion 67, equivalent regions corresponding to those regions of the central portion 67 that are not the central region 67a are regions of the electrically resistive layer 64 which in use may experience a temperature that is slightly less than the temperature of the central region 67a.

As can be seen in FIG. 4a, in accordance with the present disclosure, within the central region 67a of the central portion 67, the thickness of the electrically resistive layer 64 is increased relative to the thickness of the electrically resistive layer 64 in regions other than those corresponding to the central region 67a. In particular, the thickness of the electrically resistive layer 64 in regions of the heater assembly 6 other than the central region 67a is denoted as T₆₄ in FIG. 4a, while the thickness of the electrically resistive layer 64 in the central region 67a of the heater assembly 6 is thicker than the thickness of the electrically resistive layer 64 in regions other than the central region 67a by an amount ΔT₆₄. That is, the thickness of the electrically resistive layer 64 in the central region 67a is the sum of the thickness of the electrically resistive layer 64 in regions other than the central region 67a, i.e., T₆₄, and the additional thickness ΔT₆₄.

With reference to FIG. 4b, the central region 67a includes an electrically resistive layer 64 which is thicker by an amount ΔT₆₄ and as such protrudes above the remaining regions of the electrically resistive layer 64. Note that FIG. 4b shows the central region 67a as having a width (in the x-axis direction) that is less than the width of the heater assembly 6. However, in some implementations, the width of the central region 67a may be equal to the width of the heater assembly 6.

Without wishing to be bound by theory, and for the purposes of explanation, we consider an electrically conductive (cylindrical) wire of cross-sectional area, A. The electrical resistance of the wire, R, is expressed mathematically as:

$$R = \frac{ρ L}{A} \qquad ( 1 )$$

where, ρ is equal to the resistivity of the material of the wire, and L is equal to the length of the wire. Accordingly, the resistance of the wire, R, is inversely proportional to the cross-sectional area A of the wire.

If we apply this reasoning loosely to the electrically resistive layer 64 in the central region 67a, the cross-sectional area of the electrically resistive layer 64 in the central region 67a is increased approximately by a factor of ΔT₆₄ as compared to the cross-sectional area of the electrically resistive layer 64 in regions of the heater assembly 6 other than the central region 67a. Correspondingly, as the electrical resistance is inversely proportional to the cross-sectional area, as the cross-sectional area of the electrically resistive layer 64 in the central region 67a is relatively increased, the electrical resistance of the electrically resistive layer 64 in the central region 67a can be considered to be relatively decreased as compared to regions of the electrically resistive layer 64 other than the central region 67a.

Furthermore, it is generally understood that electrical power dissipated by a conductor (which may be dissipated as heat) is proportional to the applied current (squared) and the resistance of the conductor. Accordingly, when the resistance is relatively lower, the dissipated power is also relatively lower. Hence, when considering the electrically resistive layer 64 in the central region 67a of the heater assembly of FIGS. 4a and 4b, the power generated or dissipated as heat by the electrically resistive layer 64 in the central region 67a is relatively lower than the power generated or dissipated as heat by the electrically resistive layer 64 in regions other than the central region 67a. Accordingly, this means that there may be relatively less power generated in the electrically resistive layer 64 in the central region 67a that is capable of contributing to raising the temperature of the electrically resistive layer 64 in the central region 67a.

Thus, broadly speaking, increasing the thickness of the electrically resistive layer 64 in regions of the heater assembly 6 alters the (local) electrical resistance of the electrically resistive layer 64 in those regions, and when a current is applied to the electrically resistive layer 64, the subsequent operating temperature that those regions experience can be relatively reduced. If the thickness of the electrically resistive layer 64 is increased in regions of the electrically resistive layer 64 which would otherwise experience so-called hot-spots (such as the central region 67a), then the operating temperature can be made to be relatively lower. This may help to provide more uniform heating (more uniform temperatures) across the electrically resistive layer 64, and in particular, across the central portion 67 where liquid aerosol-generating material is supplied to the electrically resistive layer 64 for vaporisation.

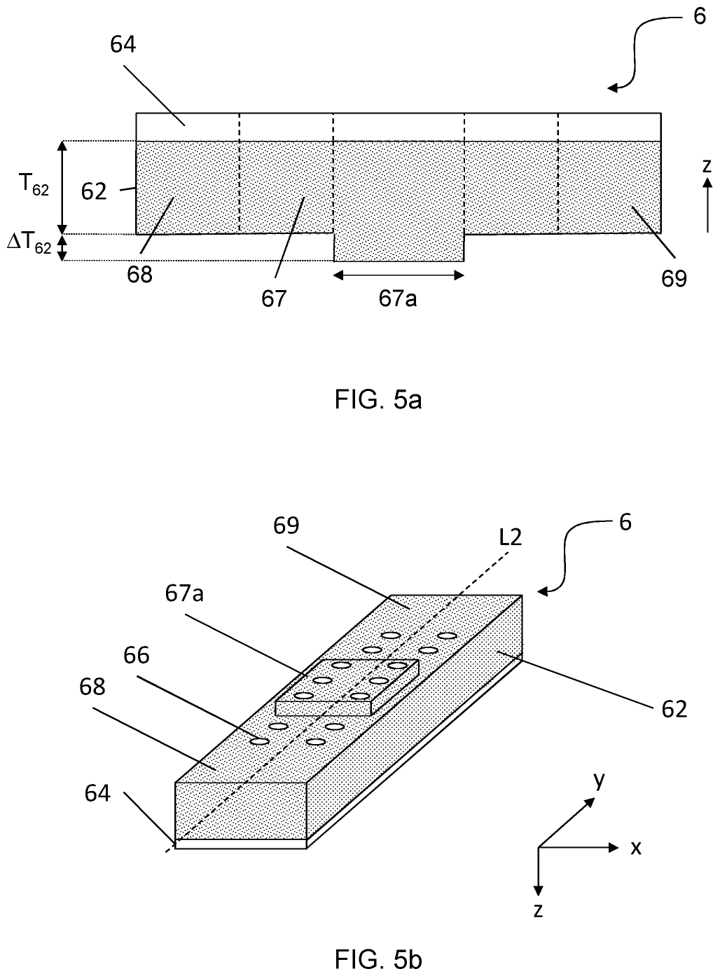

It should be appreciated that the above theory and explanations are simplistic and do not necessarily represent practical implementations. For instance, several other factors may influence the temperature that a particular region of the electrically resistive layer 64 of the heater assembly 6 reaches during application of a current thereto. (For example, see the discussion below in respect of the implementation described by FIGS. 5a and 5b). However, it is considered that by varying the thickness of the electrically resistive layer 64 in certain regions of the electrically resistive layer 64, the temperature that region operates at can be effected.

In the described example, the thickness of the electrically resistive layer 64 in the central region 67a is increased in order to relatively reduce the temperature that the electrically resistive layer 64 reaches in the central region 67a. In some implementations, this is performed in order to achieve a more uniform temperature across the electrically resistive layer 64. In some implementations, the temperature across the electrically resistive layer 64 (and in particular across the central portion 67 comprising the capillary tubes 66) can be made to be relatively uniform by appropriately setting the thicknesses of different regions of the electrically resistive layer 64. For example, the variation in temperatures across the electrically resistive layer 64 may be no more than a few degrees (for example ±5° C.) or within a few percent (for example ±2%) across the extent of the electrically resistive layer 64 (or at least across the central portion 67).

However, in some implementations, it may be desirable to provide a certain variation in temperature across the electrically resistive layer 64. That is, it may be desirable to provide regions of the electrically resistive layer 64 that operate a higher temperature than other regions of the electrically resistive layer 64. This may have an impact on the aerosol characteristics of aerosol that is subsequently generated from the heater assembly 6. Varying the thickness of the electrically resistive layer 64 can help provide or set the operational temperature for these regions. For example, increasing the thickness of the electrically resistive layer 64 in a region of the heater assembly 6 decreases the operational temperature of that region (which may to be provide inhomogeneity in an otherwise electrically resistive layer 64 having a uniform operational temperature, or to reduce or enhance the effect of any previous inhomogeneity). Additionally or alternatively, decreasing the thickness of the electrically resistive layer 64 in a region of the heater assembly 6 increases the operational temperature of that region (which may to be provide inhomogeneity in an otherwise electrically resistive layer 64 having a uniform operational temperature, or to reduce or enhance the effect of any previous inhomogeneity). Accordingly, depending on the application at hand, the described technique of varying the thickness of the electrically resistive layer 64 in different regions of the electrically resistive layer 64 can be used to control or set the operational temperature in different regions of the electrically resistive layer when a current is applied thereto, and the precise way in which this is implemented may depend on the application at hand. Suitable thicknesses for the different regions of an electrically resistive layer 64 may be found by empirical testing or computer simulation/modelling.

FIGS. 4a and 4b show a substantial change in the thickness of the electrically resistive layer 64 in the central portion 67a—indeed, in FIG. 4a, the thickness ΔT₆₄ is shown as being approximately equal to the thickness T₆₄. This is predominately shown in an exaggerated way for the purposes of clarity. It should be understood that in practical implementations, the thickness ΔT₆₄ may only be a fraction of the thickness T₆₄. For example, if T₆₄ is equal to 0.02 mm as discussed above, then ΔT₆₄ may be on the order of 0.002 mm (i.e., approximately 10% of T₆₄). Of course, this is provided only to illustrate a particular example of a heater assembly 6, and in other implementations the thicknesses of the electrically resistive layer 64 in a central portion 67a may be greater or smaller than that stated (both in terms of an absolute or relative value).

Additionally, it should be understood that FIGS. 4a and 4b show a sharp increase in the thicknesses of the electrically resistive layer 64 in the central region 67a and the other regions of the electrically resistive layer 64. However, it should be understood that the transition between regions may not be as sharp, and instead may be gradual. For example, there may be a gradual increase in the thickness of the electrically resistive layer 64 between the other regions and the central region 67a of the electrically resistive layer (e.g., following a gradual linear increase).

The way in which the varying thicknesses of the electrically resistive layer 64 is manufactured is not significant to the principles of the present disclosure, and any suitable way of providing relatively thicker or thinner regions of the electrically resistive layer 64 are contemplated. For example, the electrically resistive layer 64 may be formed having a thickness equal to ΔT₆₄+T₆₄, and subsequently etched or machined away in certain regions to reduce the thickness in these regions. Alternatively, the electrically resistive layer 64 may be formed having a thickness equal to T₆₄, and subsequently additional material is deposited on the surface thereof in certain regions to increase the thickness in these regions (e.g., via a chemical or vapour deposition technique). The actual technique implemented may be dependent on the material the electrically resistive layer 64 is formed from.

FIGS. 5a and 5b schematically represent a heater assembly 6 employing the principles of the present disclosure according to a second implementation. FIG. 5a shows the heater assembly 6 in cross-section taken along the longitudinal axis L2 of the heater assembly 6. FIG. 5b shows a perspective view of the heater assembly where the electrically resistive layer 64 is substantially hidden from view (in other words, the heater assembly has been rotated 180° around the longitudinal axis L2 as compared to FIG. 3 or 4b such that the underside of the substrate 62 is visible). Each of FIGS. 5a and 5b will be understood from FIG. 3, and like components are labelled with common reference signs. An explanation of these components is not repeated herein and instead the reader is referred to the description above.

FIG. 5a shows a cross-sectional view of the heater assembly 6, and as with FIG. 4a, shows the thicknesses of the substrate 62 and electrically resistive layer 64 (where, as described with respect to the orientation of FIGS. 3 and 4a, the thickness corresponds to the dimension of the substrate 62/electrically resistive layer 64 in the z-axis direction). The different portions of the heater assembly 6 are similarly shown in FIG. 5a as they are in FIG. 4a; that is, end portion 68 is shown on the left of the central portion 67 by the leftmost dashed line, end portion 69 is shown on the right of the central portion 67 by the rightmost dashed line, and in between the end portions 68, 69 is shown the central portion 67. Although not shown in FIG. 5a, the central portion comprises one or more capillary tubes 66 that extend substantially in the z-axis direction from the surface of the substrate 62 opposite the electrically resistive layer 64 and through the electrically resistive layer 64, as described above.

FIG. 5a also similarly shows a central region 67a of the central portion 67 of the heater assembly 6, demarked by the innermost dashed lines in FIG. 5a and also by the double-ended arrow labelled 67a. As above, it is assumed that for a heater assembly 6 as shown in FIG. 3, where the electrically resistive layer 64 is substantially uniform across the length, width and thickness of the central portion 67, an equivalent region corresponding to the central region 67a is a region of the electrically resistive layer 64 which in use may experience a temperature that is slightly greater than the temperature of the surrounding region of the central region 67a. In other words, the central region 67a is a region which would otherwise be a so-called “hot-spot”. For completeness, the regions of the central portion 67 which are not considered to be the central region 67a (i.e., the regions between the dashed lines to the left and right of the central region 67a) are considered to represent a different region of central portion 67 of the heater assembly 6. For the purposes of this discussion, it is assumed that for a heater assembly 6 as shown in FIG. 3, where the electrically resistive layer 64 is substantially uniform across the length, width and thickness of the central portion 67, equivalent regions corresponding to those regions of the central portion 67 that are not the central region 67a are regions of the electrically resistive layer 64 which in use may experience a temperature that is slightly less than the temperature of the central region 67a.

As can be seen in FIG. 5a, in accordance with the present disclosure, within the central region 67a of the central portion 67, the thickness of the substrate 62 is increased relative to the thickness of the substrate 62 in regions other than those corresponding to the central region 67a. In particular, the thickness of the substrate 62 in regions of the heater assembly 6 other than the central region 67a is denoted as T₆₂ in FIG. 5a, while the thickness of the substrate 62 in the central region 67a of the heater assembly 6 is thicker than the thickness of the substrate 62 in regions other than the central region 67a by an amount ΔT₆₂. That is, the thickness of the substrate 62 in the central region 67a is the sum of the thickness of the substrate 62 in regions other than the central region 67a, i.e., T₆₂, and the additional thickness ΔT₆₂.

With reference to FIG. 5b, the central region 67a includes substrate 62 which is thicker by an amount ΔT₆₂ and as such protrudes above the remaining regions of the substrate 62. Note that FIG. 5b shows the central region 67a as having a width (in the x-axis direction) that is less than the width of the heater assembly 6. However, in some implementations, the width of the central region 67a may be equal to the width of the heater assembly 6.

Without wishing to be bound by theory, it is considered that a volume of liquid aerosol-generating material is capable of acting as a heat-sink. For example, a unit mass of liquid aerosol-generating material requires a certain amount of heat to convert the mass of liquid aerosol-generating material to the vapour phase without a change in temperature—this is the so-called latent heat of vaporisation. Accordingly, when a mass of liquid is supplied with heat energy, e.g., from an electrically resistive layer 64, if the amount of heat energy generated by the electrically resistive layer 64 is greater than the latent heat of vaporisation, then the excess heat energy generated is dissipated into the electrically resistive layer 64 and contributes to raising the temperature of the electrically resistive layer 64.

With reference back to FIG. 5a, the heater assembly 6 includes capillary tubes 66 that extend from the surface of the substrate 62 opposite the electrically resistive layer 64 through to the electrically resistive layer 64. These capillary tubes 66 are distributed throughout the central portion 67 of the heater assembly 6, including the central region 67a. However, in the central region 67a, the capillary tubes 66 are relatively longer as compared to capillary tubes 66 that are present in the regions other than the central region 67a. In particular, the capillary tubes 66 in regions other than the central region 67a extend a length equal to the thickness of the substrate T₆₂ plus the thickness of the electrically resistive layer 64. Conversely, the capillary tubes 66 in the central region 67a extend a length equal to the thickness of the substrate T₆₂ plus the thickness of the electrically resistive layer 64 plus the additional thickness of the substrate ΔT₆₂. Because the capillary tubes 66 in the central region 67a of the heater assembly 6 are relatively longer than the capillary tubes 66 in the regions other than the central region 67a, the capillary tubes 66 in the central region 67a are capable of holding relatively more liquid aerosol-generating material. In particular, the additional amount of liquid aerosol-generating material that the capillary tubes 66 in the central region 67a are able to hold is proportional to the additional thickness of the substrate ΔT₆₂ (and in particular, the number of capillary tubes 66 in the central region 67a multiplied by the cross-sectional area of the capillary tubes 66a multiplied by the additional thickness, ΔT₆₂).

Accordingly, the substrate 62 in the central region 67a having an increased thickness is capable of storing a relatively greater mass of liquid aerosol-generating material than the regions of the substrate 62 other than the central region 67a (assuming across the central portion 67 of the heater assembly 6 there is provided a suitable feed of liquid aerosol-generating material). Due, in part, to the relatively increased mass of liquid aerosol-generating material that is capable of being stored in the capillary tubes 66 of the central region 67a, the central region 67a is thought to act as a more effective heat-sink. Accordingly, if the electrically resistive layer 64 generates the same amount of heat energy when energised, when utilising a central portion 67a having a substrate 62 with an increased thickness, relatively more of the heat energy generated is provided to the mass of liquid aerosol-generating material held in the capillary tubes 66 and therefore there is relatively less (if any) excess heat energy generated by the electrically resistive layer 64. Therefore, there is a relatively smaller amount of heat energy generated which can be used to increase the operational temperature of the electrically resistive layer 64, subsequently leading to a relative reduction in the operational temperature of the electrically resistive layer 64 in that region (i.e., the central region 67a).

Thus, broadly speaking, increasing the thickness of the substrate 62 in regions of the heater assembly 6 alters the (local) heat-sink performance of the substrate 62 in those regions, and when a current is applied to the electrically resistive layer 64, the subsequent operating temperature of the regions of the electrically resistive layer 64 experience can be relatively reduced. If the thickness of the substrate 62 is increased in regions corresponding to electrically resistive layer 64 which would otherwise experience so-called hot-spots (such as the central region 67a), then the operating temperature of the electrically resistive layer 64 can be made to be relatively lower. This may help to provide more uniform heating (more uniform temperatures) across the electrically resistive layer 64, and in particular, across the central portion 67 where liquid aerosol-generating material is supplied to the electrically resistive layer 64 for vaporisation.

It should be appreciated that the above theory and explanations are simplistic and do not necessarily represent practical implementations. For instance, several other factors may influence the temperature that a particular region of the electrically resistive layer 64 of the heater assembly 6 reaches during application of a current thereto. However, it is considered that by varying the thickness of the substrate 62 in certain regions of the substrate 62, the temperature of the electrically resistive layer 64 that that region operates at can be effected.

In the described example, the thickness of the substrate 62 in the central region 67a is increased in order to relatively reduce the temperature that the electrically resistive layer 64 reaches in the central region 67a. In some implementations, this is performed in order to achieve a more uniform temperature across the electrically resistive layer 64. In some implementations, the temperature across the electrically resistive layer 64 (and in particular across the central portion 67 comprising the capillary tubes 66) can be made to be relatively uniform by appropriately setting the thicknesses of different regions of the substrate 62. For example, the variation in temperatures across the electrically resistive layer 64 may be no more than a few degrees (for example ±5° C.) or within a few percent (for example ±2%) across the extent of the electrically resistive layer 64 (or at least across the central portion 67).

However, in some implementations, it may be desirable to provide a certain variation in temperature across the electrically resistive layer 64. That is, it may be desirable to provide regions of the electrically resistive layer 64 that operate a higher temperature than other regions of the electrically resistive layer 64. This may have an impact on the aerosol characteristics of aerosol that is subsequently generated from the heater assembly 6. Varying the thickness of the substrate 62 can help provide or set the operational temperature of the electrically resistive layer 64 for these regions. For example, increasing the thickness of the substrate 62 in a region of the heater assembly 6 decreases the operational temperature of the electrically resistive layer 64 of that region (which may to be provide inhomogeneity in an otherwise electrically resistive layer 64 having a uniform operational temperature, or to reduce or enhance the effect of any previous inhomogeneity). Additionally or alternatively, decreasing the thickness of the substrate 62 in a region of the heater assembly 6 increases the operational temperature of the electrically resistive layer 64 of that region (which may to be provide inhomogeneity in an otherwise electrically resistive layer 64 having a uniform operational temperature, or to reduce or enhance the effect of any previous inhomogeneity). Accordingly, depending on the application at hand, the described technique of varying the thickness of the substrate 62 in different regions of the substrate 62 can be used to control or set the operational temperature in different regions of the electrically resistive layer 64 when a current is applied thereto, and the precise way in which this is implemented may depend on the application at hand. Suitable thicknesses for the different regions of the substrate 62 may be found by empirical testing or computer simulation/modelling.

FIGS. 5a and 5b show a reasonable change in the thickness of the substrate 62 in the central portion 67a. It is thought that the influence on the operational temperature of the electrically resistive layer 64 in a given region is more sensitive to changes in the thickness of the electrically resistive layer 64 than the substrate 62. That is, the thickness ΔT₆₂ is likely to need to be greater than the thickness ΔT₆₄ to achieve the same or similar effect. Nonetheless, like with the implementations of FIGS. 4a and 4b, it should be understood that in practical implementations, the thickness ΔT₆₂ may be a fraction of the thickness T₆₂. For example, if T₆₂ is equal to 0.10 mm as discussed above, then ΔT₆₂ may be on the order of 0.01 mm (i.e., approximately 10% of T₆₂). Of course, this is provided only to illustrate a particular example of a heater assembly 6, and in other implementations the thicknesses of the substrate 62 in a central portion 67a may be greater or smaller than that stated (both in terms of an absolute or relative value).

Additionally, it should be understood that FIGS. 5a and 5b show a sharp increase in the thicknesses of the substrate 62 in the central region 67a and the other regions of the substrate 62. However, it should be understood that the transition between regions may not be as sharp, and instead may be gradual. For example, there may be a gradual increase in the thickness of the substrate 62 between the other regions and the central region 67a of the substrate 62 (e.g., following a gradual linear increase).

The way in which the varying thicknesses of the substrate 62 is manufactured is not significant to the principles of the present disclosure, and any suitable way of providing relatively thicker or thinner regions of the substrate 62 are contemplated. For example, the substrate 62 may be formed having a thickness equal to ΔT₆₂+T₆₂, and subsequently etched or machined away in certain regions to reduce the thickness in these regions. Alternatively, the substrate 62 may be formed having a thickness equal to T₆₂, and subsequently additional material is deposited or grown on the surface thereof in certain regions to increase the thickness in these regions (e.g., via a chemical or vapour deposition technique, or a sintering technique). The actual technique implemented may be dependent on the material the substrate 62 is formed from.

Hence, it has been described above that the thickness of at least one of the electrically resistive layer 64 and substrate 62 are set so as to be different at different portions (or regions) of the heater assembly 6.

Varying the thickness of the electrically resistive layer 64 and substrate 62 may be performed so as to remove or reduce hot-spots generated in certain portions of an otherwise uniform thickness heater assembly 6. In particular, for those regions where hot-spots occur, increasing the thickness of the electrically resistive layer 64 or substrate 62 may help to reduce the overall operating temperature (i.e., the temperature achieved when a current is applied) of the electrically resistive layer 64 in those regions. Conversely, varying the thickness of the electrically resistive layer 64 and substrate 62 may be performed so as to increase the temperature in certain portions of an otherwise uniform thickness heater assembly 6. For example, instead of so-called hot-spots, it may be considered that there are portions of the electrically resistive layer 64 that are relatively colder than the other portions of the electrically resistive layer 64. By reducing the thickness of the electrically resistive layer 64 or substrate 62 in these regions, the overall operating temperature (i.e., the temperature achieved when a current is applied) of the electrically resistive layer 64 may be relatively increased in those regions. Accordingly, in some applications, it may be desirable to modify the thicknesses of the electrically resistive layer 64 or substrate 62 in order to provide a substantially uniform operating temperature across the electrically resistive layer 64, or at least across the central portion 67 of the electrically resistive layer 64.

Alternatively, varying the thickness of the electrically resistive layer 64 and substrate 62 may be performed so as to provide a non-uniform operating temperature of the electrically resistive layer 64 across the electrically resistive layer 64. For example, it may be desired to introduce hot-spots (or modify the extent of already existing hot-spots) at certain portions of the electrically resistive layer 64. For those regions where creation of a hot-spot is desired, decreasing the thickness of the electrically resistive layer 64 or substrate 62 may help to increase the overall operating temperature (i.e., the temperature achieved when a current is applied) of the electrically resistive layer 64 in those regions. Accordingly, in some applications, it may be desirable to modify the thicknesses of the electrically resistive layer 64 or substrate 62 in order to provide a non-uniform operating temperature across the electrically resistive layer 64, or at least across the central portion 67 of the electrically resistive layer 64.

FIGS. 4a and 4b described an implementation in which the thickness of the electrically resistive layer 64 is set differently in different regions of the heater assembly 6, while FIGS. 5a and 5b described an implementation in which the thickness of the substrate 62 is set differently in different regions of the heater assembly 6. However, it should be appreciated that both the thickness of the electrically resistive layer 64 and the substrate 62 do not need to be varied in the same regions or portions, but may be varied in different regions or portions of the heater assembly 6. In this regard, it should be appreciated that a region (or portion) defined for the electrically resistive layer 64 may not be equivalent to a region (or portion) defined for the substrate 62. For example, it may be that the substrate 62 in the central portion 67 is set to be relatively thicker than the substrate 62 in the end portions 68, 69 of the heater assembly 6, but the electrically resistive layer 64 is set to be thicker only in the central region 67a of the central portion 67. Additionally, it should be understood that that thickness of the substrate 62 and electrically resistive layer 64 do not need to be varied in the same way in a given region or portion. For example, the thickness of substrate 62 may be set to be thinner in the central region 67a compared to the remaining regions of the heater assembly 6, while the electrically resistive layer 64 may be set to be thicker in the central region 67a compared to the remaining regions of the heater assembly 6. Indeed, in some implementations, the thickness of the heater assembly 6 itself may be unchanged, despite the thickness of the electrically resistive layer 64 and substrate 62 varying in different portions of the heater assembly 6. Broadly speaking, any combination of the abovementioned techniques may be implemented in order to provide a heater assembly having at least one of the electrical resistive layer 64 and substrate 62 set so as to be different at different portions of the heater assembly 6.

With reference to FIGS. 4a and 4b, it should also be understood that by increasing the thickness of the electrically resistive layer 64 in a particular region, the length of the capillary tubes 66 is also increased (in a similar manner to as described in the implementation shown in FIGS. 5a and 5b). Therefore, there may be some reduction of the operational temperature of the electrically resistive layer 64 in the particular region owing to the increased mass of liquid aerosol-generating material stored in the particular region. However, given that the additional thickness ΔT₆₄ is considered to be smaller for a similar effect on the operational temperature of the electrically resistive layer 64 for the additional thickness ΔT₆₂, it is considered that any effect arising from the lengthening of the capillary tubes 66 by the additional thickness ΔT₆₄ of the electrically resistive layer 64 is minimal compared to the effect provided by the change in (local) resistance of the electrically resistive layer 64 caused by the additional thickness ΔT₆₄.

In addition, while the above has focused on a substantially two regions of the heater assembly 6 where the thickness of the substrate 62 and electrically resistive layer 64 are varied (i.e., the central region 67a and the region other than the central region 67a), it should be appreciated that multiple regions may be provided to the heater assembly 6, each having different thickness of at least one of the electrically resistive layer 64 and substrate 62.

It should be appreciated that a cartomiser 3 (or more generally an aerosol provision system 1) employing the heater assembly 6 as described above may have the heater assembly 6 configured in any suitable manner to achieve the desired thermal property of the heater assembly in use (e.g., the creation or enhancement of hot-spots, or the more uniform operational temperature across the electrically resistive layer 64 of the heating assembly 6). As described above, several factors may dictate the appearance of hot-spots. On the one hand, these factors may be intrinsic to the heater assembly 6. For example, the local resistance(s) of the electrically resistive layer 64 and/or the amount (mass) of liquid held (or capable of being held) locally in different regions of the heater assembly 6. On the other hand, these factors may be external to the heater assembly 6 and be a feature of the cartomiser 3 (or aerosol provision system 1) itself. For example, as described above, the specific air flow direction and/or extent on or around the heater assembly 6 may lead to the generation of hot-spots. Additionally, if present, the wicking element (or more generally a (liquid) aerosol-generating material transport mechanism) may be configured, deliberately or otherwise, to supply liquid aerosol-generating material at different rates to different regions of the heater assembly 6. Accordingly, it should be understood that these external factors may influence the location(s) of heater assembly 6 at which the thickness of the electrically resistive layer 64 and/or substrate 62 is varied. Put another way, the heater assembly 6 is configured so that the thickness of the electrically resistive layer 64 and/or substrate 62 is varied/set at suitable locations of the heater assembly 6 based on the external factors governed by the cartomiser 3 (or aerosol provision system 1) the heater assembly 6 is to be used in.

Therefore, in accordance with one aspect of the present disclosure, an aerosol provision system 1 comprises a heater assembly 6 (as described above) and an air inlet (such as air inlet hole 22) configured to direct a flow of air (generated by a user inhaling on the mouthpiece 33 of the aerosol provision system 1) towards the heater assembly 6 such that, in use, the cooling effect of said air flow on the heater assembly 6 is greater at a portion of the heater assembly 6 where the thickness of at least one of the electrically resistive layer 64 and substrate is relatively thinner compared to a cooling effect of said flow of air on the heater assembly 6 at a portion of the heater assembly 6 where the thickness of at least one of the electrically resistive layer 64 and substrate is relatively thicker. Accordingly, in such implementations, the reduced impact of cooling from the air flow at the portion of heater assembly 6 where the thickness of at least one of the electrically resistive layer 64 and substrate is relatively thicker (as compared to the effectiveness of the cooling from the air flow at the portion(s) of the heater assembly 6 where the thickness of at least one of the electrically resistive layer 64 and substrate is relatively thinner) can be offset by increasing the thickness of at least one of the electrically resistive layer 64 and substrate to provide cooling via a reduction in the electrical resistance of the electrically resistive layer 64 and/or an increase in the local amount/mass of liquid aerosol-generating material stored in that portion of the heater assembly 6.

Additionally, or alternatively, in accordance with another aspect of the present disclosure, an aerosol provision system 1 comprises a heater assembly 6 (as described above) and a (liquid) aerosol-generating material transport mechanism (such as the wicking element/material described above). The aerosol-generating material transport mechanism is arranged so as to provide the (liquid) aerosol-generating material at a first rate to a portion of the heater assembly 6 where the thickness of at least one of the electrically resistive layer 64 and substrate is relatively thicker and to supply aerosol-generating material at a second rate to a portion of the heater assembly 6 where the thickness of at least one of the electrically resistive layer 64 and substrate is relatively thinner, wherein the first rate is less than the second rate. Accordingly, in such implementations, the reduced impact of cooling from the (relatively low) supply of liquid aerosol-generating material to the portion of the heater assembly 6 where the thickness of at least one of the electrically resistive layer 64 and substrate is relatively thicker (as compared to the effectiveness of the cooling from the relative high supply of liquid to the portion of the heater assembly 6 where the thickness of at least one of the electrically resistive layer 64 and substrate is relatively thicker) can be offset by increasing the thickness of at least one of the electrically resistive layer 64 and substrate to provide cooling via a reduction in the electrical resistance of the electrically resistive layer 64 and/or an increase in the local amount/mass of liquid aerosol-generating material stored in that portion of the heater assembly 6.

It should be appreciated that the configuration of the cartomiser 3 accommodating the heater assembly 6 is provided as an example configuration of such a cartomiser 3. The principles of the present disclosure apply equally to other configurations of the cartomiser 3 (for example, comprising similar or different components to those as shown in FIGS. 1 and 2, and a similar or different layout to that shown in FIG. 2). That is, the cartomiser 3 and the relative position of the heater assembly 6 in the cartomiser 3 is not significant to the principles of the present disclosure. Broadly speaking, a cartomiser is likely to comprise a top end (having the mouthpiece orifice 41) and a bottom end. In the examples shown above, the heater assembly 6 is arranged to be below the reservoir 46, substantially horizontal to the longitudinal axis of the cartomiser 3, and arranged in an airflow path that is substantially perpendicular to longitudinal axis of the heater assembly. However, this need not be case, and in other implementations the cartomiser 3 may be configured differently depending on the particular design and application at hand. For example, the heater assembly 6 may be arranged such that airflow is substantially parallel to the longitudinal axis of the heater assembly, e.g., along the exposed surface of the electrically resistive layer 64. For example, the upper clamping unit 5 may not be provided with the central air passage 58 and instead the air passage may be provided to one side of the upper clamping unit 5. Air may enter the cartomiser 3 by a suitable inlet and flow along the longitudinal surface of the heater assembly 6 (and along the electrically resistive layer 64) before passing in a substantially vertical direction through the air passage 58 positioned at one end of the upper sealing unit 5 (e.g., the end opposite the air inlet). The outer housing 4 and mouthpiece orifice 41 may be suitably configured. In such an example, the entirely of the lower surface of the heater assembly 6 may be exposed to the reservoir 46. In such implementations, the capillary tubes 66 may be disposed across the heater assembly 6, not just within the central portion 67 of the heater assembly 6 (provided the electrically resistive layer 64 is capable of coupling to a power source). Hence, although the heater assembly 6 has been described in the specific context of the example cartomiser 3 of FIGS. 1 and 2, the principles described herein can be applied to different heater assemblies for use in different cartomisers 3.

In the example shown in FIG. 2, the contact pads 75 directly contact the electrically resistive layer 64 of the heater assembly 6. However, the cartomiser 3 may be provided with any suitable arrangement that facilitates the electrical contact between the aerosol provision device 2 and the heater assembly 6. For example, in some implementations, electrical wiring or other electrically conductive elements may extend between the electrically resistive layer 64 and the contact pads 75 of the cartomiser 3. This may particularly be the case when the heater assembly 6 has its largest dimension (e.g., its length) less than a minimum distance between the contact pads 75. The distance between the contact pads 75 may be dictated by the electrical contacts on the aerosol provision device 2.

In addition, in the described examples, the heater assembly 6 is orientated such that the electrically resistive layer 64 faces towards the bottom of the cartomiser 3. However, the orientation of the heater assembly 6 is not limited to this and, in other implementations, the heater assembly 6 may be provided in alternative orientations, for example, where the electrically resistive layer faces away from the bottom of the cartomiser 3.

It should also be appreciated that while the above has described a cartomiser 3 which includes the heater assembly 6, in some implementations the heater assembly 6 may be provided in the aerosol provision device 2 itself. For example, the aerosol provision device 2 may comprise the heater assembly 6 and a removable cartridge (containing a reservoir of liquid aerosol-generating material). The heater assembly 6 is provided in fluid contact with the liquid in the cartridge (e.g., via a suitable wicking element or via another fluid transport mechanism). Alternatively, the aerosol provision device 2 may include an integrated liquid storage area in addition to the heater assembly 6 which may be refillable with liquid. More broadly, the aerosol provision system (which encompasses a separable aerosol provision device and cartomiser/cartridge or an integrated aerosol provision device and cartridge) includes the heater assembly.

Additionally, the above has described a heater assembly 6 in which an electrically resistive layer 64 is provided on a surface of the respective substrate. In the aerosol provision system 1 of FIG. 2, electrical power is supplied to the electrically resistive layer 64 via the contact pads 75. Accordingly, an electrical current is able to flow through the electrically resistive layer 64 from one end to the other to cause heating of the electrically resistive layer 64. However, it should be understood that electrical power for the purposes of causing the electrically resistive layer 64 to heat may be provided via an alternative means, and in particular, via induction. In such implementations, the aerosol provision system 1 is provided with a coil (known as a drive coil) to which an alternating electrical current is applied. This subsequently generates an alternating magnetic field. When the electrically resistive layer 64 is exposed to the alternating magnetic field (and it is of sufficient strength), the alternating magnetic field causes electrical current (Eddy currents) to be generated in the electrically resistive layer 64. These currents can cause Joule heating of the electrically resistive layer 64 owing to the electrical resistance of this layer 64. Depending on the material which the electrically resistive layer 64 is formed, heating may additionally be generated through magnetic hysteresis (if the material is ferro- or ferrimagnetic). More generally, the electrically resistive layer 64 is an example of a heater layer of the heater assembly 6 which is configured to generate heat when supplied with energy (e.g., electrical energy), which, for example, may be provided through direct contact or via induction. Additional ways of causing the heater layer to generate heat are also considered within the principles of the present disclosure.

Moreover, it should be understood that in some implementations, an additional layer or layers, e.g., serving as a protective layer, may be disposed on top of the electrically resistive layer 64. In such implementations, the capillary tubes 66 still extend to an opening on the electrically resistive layer 64 but may additionally extend through the additional layer(s). More broadly, the capillary tubes 66 extend through the heater assembly 6 to an opening at a surface of a side of the heater assembly 6 comprising the electrically resistive layer 64, which includes an opening in the electrically resistive layer 64 itself as well as an opening in any additional layer(s) positioned above the electrically resistive layer 64.

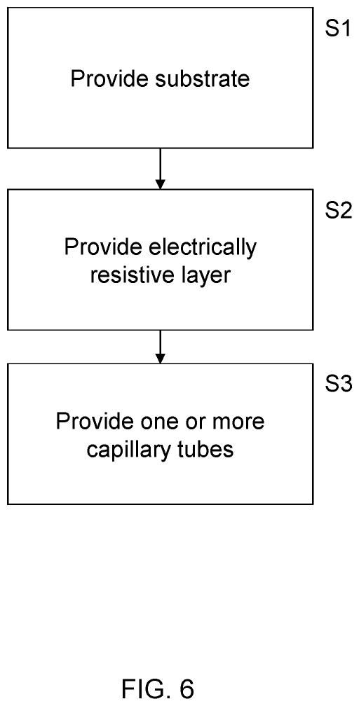

FIG. 6 depicts an example method for manufacturing a heater assembly 6.

The method begins at step S1 by providing a substrate 62. The way in which the substrate 62 is formed is not significant to the principles of the present disclosure. For example, the substrate 62 may be cut from a portion of cultured quartz or formed via a sintering process by sintering quartz powders/fibres, for example.

The method then proceeds to step S2 whereby the electrically resistive layer 64 is provided on a surface of the substrate 62. The way in which the electrically resistive layer 64 is formed on the surface of the substrate 62 is not significant to the principles of the present disclosure. For example, the electrically resistive layer 64 may be a sheet of metal (e.g., titanium) adhered, welded, or the like to the substrate 62. Alternatively, the electrically resistive layer 64 may be formed through a vapour or chemical deposition technique using the substrate 62 as a base.

It should also be appreciated that step S2 may alternatively occur before step S1. For example, a further alternative is to grow or culture the substrate 62 using the electrically resistive layer 64 as a base.

In accordance with the principles of the present disclosure, the thickness of at least one of the electrically resistive layer 64 and substrate 62 is set so as to be different at different portions of the heater assembly 6. As described above, precisely what portions of the heater assembly 6 are set such that the thickness of the substrate 62 or electrically resistive layer 64 are varied with respect to other portions depends on the application at hand and the desired heating characteristics of the heater assembly 6.

In the described example, after step S2, the method proceeds to step S3. At step S3, one or more capillary tubes 66 are formed in the substrate 62/electrically resistive layer 64. As noted above, the capillary tubes 66 extend from a surface of the substrate 62/heater assembly 6, through the electrically resistive layer 64 provided on the first surface of the substrate 62. That is, the capillary tubes 66 extend all the way through the heater assembly 6. The capillary tubes 66 may be formed by laser drilling, as noted above, or any other suitable technique.

It should be appreciated that step S3 may be performed prior to step S2 (and equally step S3 may follow step S1 where step S2 is performed prior to step S1). That is to say, the capillary tubes 66 may be formed in the substrate 62 prior to applying the electrically resistive layer 64.

Broadly, it should be understood that the method of FIG. 6 is an example method only, and adaptations to the steps or ordering of the steps of this method are contemplated within this disclosure, for example, as described above.

After step S3, the heater assembly 6 is formed, and subsequently may be assembled to form the cartomiser 3 (or more generally, the heater assembly 6 may be positioned in an aerosol provision system 1).

Thus, there has been described a heater assembly for an aerosol provision system, the heater assembly including: a substrate; a heater layer configured to generate heat when supplied with energy, the heater layer provided on a first surface of the substrate; and one or more capillary tubes extending from another surface of the substrate through the heater layer provided at the first surface of the substrate, wherein the thickness of at least one of the heater layer and substrate is set so as to be different at different portions of the heater assembly. Also described is an aerosol provision system comprising a heater assembly and a method for manufacturing a heater assembly.

It should be appreciated that in respect of the variation of the thickness of the electrically resistive layer 64 in a region of the heater assembly 6, the present disclosure may be otherwise summarised as: a heater assembly 6 for an aerosol provision system 1, the heater assembly 6 including: a substrate 62; a heater layer 64 configured to generate heat when supplied with energy, the heater layer 64 provided on a first surface of the substrate 62; and one or more capillary tubes 66 extending from another surface of the substrate 62 through the heater layer 64 provided at the first surface of the substrate 62. The heater layer 64 is configured such that different portions of the heater layer 64 have different electrical resistances. The electrical resistance of the different portions of the heater layer is set based on the thickness of the heater layer in a given portion.

It should be appreciated that in respect of the variation of the thickness of the substrate 62 in a region of the heater assembly 6, the present disclosure may be otherwise summarised as: a heater assembly 6 for an aerosol provision system 1, the heater assembly 6 including: a substrate 62; a heater layer 64 configured to generate heat when supplied with energy, the heater layer 64 provided on a first surface of the substrate 62; and one or more capillary tubes 66 extending from another surface of the substrate 62 through the heater layer 64 provided at the first surface of the substrate 62. The substrate 62 is configured such that different portions of the substrate 62 are capable of holding different amounts of aerosol-generating material. The amount of aerosol-generating material the different portions of the substrate 62 are configured to hold is set based on the thickness of the substrate 62 in a given portion.

While the above described embodiments have in some respects focussed on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. A heater assembly for an aerosol provision system, the heater assembly comprising:
a substrate;
a heater layer configured to generate heat when supplied with energy, the heater layer provided on a first surface of the substrate; and
one or more capillary tubes extending from another surface of the substrate through the heater layer provided at the first surface of the substrate,
wherein the thickness of at least one of the heater layer and substrate is set so as to be different at different portions of the heater assembly.

2. The heater assembly of claim 1, wherein the temperature that the heater layer in a given portion is capable of reaching is based in part on the thickness of at least one of the heater layer and substrate at the given portion of the heater assembly.

3. The heater assembly of claim 1, wherein the thickness of the heater layer is different at different portions of the heater assembly.

4. The heater assembly of claim 3, wherein the electrical resistance of the heater layer is a function of the thickness of the heater layer, and wherein the temperature that the heater layer in a given portion of the heater assembly is capable of reaching is based in part on the electrical resistance of the heater layer in the given portion of the heater assembly.

5. The heater assembly of claim 3, wherein the heater layer is relatively thicker at a first portion of the heater assembly.

6. The heater assembly of claim 5, wherein the electrical resistance of the heater layer is relatively reduced at the first portion of the heater assembly.

7. The heater assembly of claim 5, wherein the first portion of the heater assembly is a portion corresponding to a central region of the heater assembly.

8. The heater assembly of claim 1, wherein the thickness of the substrate is different at different portions of the heater assembly.

9. The heater assembly of claim 8, wherein the amount of aerosol-generating material the substrate is capable of holding is a function of the thickness of the substrate, and wherein the temperature that the heater layer in a given portion of the heater assembly is capable of reaching is based in part on the amount of aerosol-generating material held in the substrate in the given portion of the heater assembly.

10. The heater assembly of claim 8, wherein the substrate is relatively thinner at a second portion of the heater assembly.

11. The heater assembly of claim 10, wherein the amount of aerosol-generating material capable of being held in the substrate is relatively reduced at the second portion of the heater assembly.

12. The heater assembly of claim 10, wherein the second portion of the heater assembly is a portion corresponding to a region other than a central region of the heater assembly.

13. The heater assembly of claim 1, wherein the dimension of the heater assembly that is perpendicular to the first surface of the heater assembly corresponds to the thickness of the heater assembly.

14. The heater assembly of claim 1, wherein the thickness of at least one of the heater layer and substrate is set such that the temperature the heater layer is capable of reaching is substantially uniform or uniform across the heater layer.

15. An aerosol provision system comprising the heater assembly of claim 1.

16. The aerosol provision system of claim 15, wherein the aerosol provision system further comprises an air inlet configured to direct a flow of air towards the heater assembly such that, in use, a cooling effect of said air flow on the heater assembly is greater at a portion of the heater assembly where the thickness of at least one of the heater layer and substrate is relatively thinner compared to a cooling effect of said flow of air on the heater assembly at a portion of the heater assembly where the thickness of at least one of the heater layer and substrate is relatively thicker.

17. The aerosol provision system of claim 15, wherein the aerosol provision system further comprises an aerosol-generating material transport mechanism configured to, in use, supply aerosol-generating material at a first rate to a portion of the heater assembly where the thickness of at least one of the heater layer and substrate is relatively thicker and to supply aerosol-generating material at a second rate to a portion of the heater assembly where the thickness of at least one of the heater layer and substrate is relatively thinner, wherein the first rate is less than the second rate.

18. A method for manufacturing a heater assembly for an aerosol provision system, the method comprising:
providing a substrate;
providing a heater layer on a first surface of the substrate, the heater layer configured to generate heat when supplied with energy; and
providing one or more capillary tubes extending from another surface of the substrate through the heater layer provided at the first surface of the substrate,
wherein the thickness of at least one of the heater layer and substrate is set so as to be different at different portions of the heater assembly.

19. A heater means for an aerosol provision system, the heater means comprising:
a substrate;
heater layer means configured to generate heat when supplied with energy, the heater layer means provided on a first surface of the substrate; and
capillary means extending from another surface of the substrate through the heater layer means provided at the first surface of the substrate,
wherein the thickness of at least one of the heater layer means and substrate is set so as to be different at different portions of the heater means.
